(19) United States
(12) Patent Application Publication
(10) Pub. No.: US 2002/0198617 A1
(43) Pub. Date: Dec. 26, 2002

(54) System and method for controlling priority of lots employed in MES

(76) Inventors: Wonin Baek, Seongnam-si (KR); Heungchul Park, Seongnam-si (KR); Joodeok Yun, Seongnam-si (KR); Jonghyun Baek, Daejeon-si (KR); Joosuck Jung, Seongnam-si (KR)

Correspondence Address: PENNIE & EDMONDS LLP, 1667 K STREET NW, SUITE 1000, WASHINGTON, DC, 20006

(21) Appl. No.: 09/983,432

(22) Filed: Oct. 24, 2001

(30) Foreign Application Priority Data
Jun. 22, 2001 (KR) 2001-35714

(51) Int. Cl. G06F 19/00

(52) U.S. Cl. 700/101; 700/96

(57) ABSTRACT

The present invention relates to a method for controlling priority of lots employed in a MES, and more particularly, to a method for controlling priority of lots employed in a MES, wherein the priority of the lots provided by the MES can be automatically set up depending on a processing cycle time.

### FIELD OF THE INVENTION

The present invention relates to a method for controlling priority of lots employed in a MES (Manufacturing Execution System), and more particularly, to a method for controlling priority of lots employed in a MES, wherein the priority of the lots provided by the MES can be automatically set up depending on a processing cycle time.

### BACKGROUND OF THE INVENTION

In general, in a semiconductor fabrication line, one hundred or more processes are carried out for manufacturing one hundred thousand or more wafers to produce several ten kinds of semiconductor products. A large number of processing equipments are employed and are under operation for 24 hours a day.

In addition, in the semiconductor fabricating line, large volume of lots, each being a unit of a magazine containing a plurality of wafers, e.g., 25 wafers, are conveyed to and loaded into each fabricating process. Lot data are inputted to a host and managed by an operator upon completion of a fabricating process.

A system for managing the progress, and history of the lots and resources in various kinds of manufacturing lines, e.g., the semiconductor fabricating line is, called a MES (Manufacturing Execution System).

A semiconductor fabricating or processing system is connected with the host by way of an equipment server (hereinafter, referred to as “EQS”) that manages the equipments of each process in respective equipment groups.

Each of the manufacturing equipments reports to the host the progress situation and result of the respective processes. The host performs functions of running and managing a series of the semiconductor fabricating processes.

Due to complexity and diversity of the semiconductor fabricating processes of about 800 or more process steps, there are many kinds of equipments with various uses. The semiconductor fabricating equipments are generally classified into four kinds: pre-processing equipment; assembly equipment; test and inspection equipment; and other process-specific equipment.

Therefore, it is difficult to effectively manage the semiconductor fabricating processes. Most of the semiconductor fabricating equipments are supervised and managed by a centralized control using a protocol for the control thereof. A typically used protocol is a SECS (Semiconductor Equipment Communications Standard) that is a communication standard between the semiconductor fabricating equipments and a central control post, e.g., EQS.

For instance, when an operator establishes predetermined data, for example, data required for, e.g., a metal deposition process, in a corresponding semiconductor fabricating equipment by using SECS messages. The SECS messages are one of the protocols used for exchanging data between the EQS and the semiconductor fabricating equipment. The data establishment result is displayed on a monitor mounted on the semiconductor fabricating equipment. For instance, “Lot Name” and “Process Name” are displayed on the monitor in the form of a menu. Lot names representing lot identification codes defined by the SECS message are displayed in rows below the “Lot Name,” and process names representing the metal deposition process performed for the lots are displayed in rows below the “Process Name.”

FIG. 1 is a schematic view showing a processing cycle time in a semiconductor manufacturing process.

As shown in FIG. 1, the semiconductor fabricating processes include an assembly process, an inspection process, a packaging process and a shipping process, ranging from the input of raw materials to the shipment of final products.

In FIG. 1, “queue time” indicates a period of time from completion of a previous process to the start of a next process, and “process time” indicates a period of time during which an operation is actually performed. In addition, the “processing cycle time” represents the sum of the queue time and the process time in each complete process. The processing cycle time is classified into a measured time which is actually measured on the manufacturing site, and an estimated time which is inputted by an operator.

When a lot is put into a manufacturing process, the time by which the lot must be finished is designated as a time, a so-called “due date.”

FIG. 2 is a schematic view showing the due date for a lot in the semiconductor manufacturing process.

That is, with respect to the “lot” as shown in FIG. 2, a solid line with an arrow on the left side of the lot represents a period of time during which the process thereon has actually been completed up there, and a dotted line with an arrow on the right side of the lot represents a period of time during which the operation should be performed from then on.

As shown in FIG. 2, the due date for the lot can easily be obtained from a prearranged production target date of the lot. The prearranged target date of the lot may be obtained from the sum of the present time and the remaining processing cycle time.

Conventionally, an operator on the product manufacturing site manually calculates the processing cycle time. Based on the calculated processing cycle time, the operator creates a list for a lot. Thereafter, the process is sequentially performed from a lot having the highest priority by referring to the list.

The conventional method as described above, however, is not efficient, and further, does not ensure the optimization of putting the priority. As a result, the process time may be delayed, and consequently, deadline for shipping the products may be missed.

### SUMMARY OF THE INVENTION

The present invention is contemplated to solve the above problems. An object of the present invention is to provide a method for controlling priority of lots employed in a MES, wherein that the priority of the lots provided by the MES can be automatically set up depending on a processing cycle time.

According to an aspect of the present invention for achieving the above objects, there is provided a method for controlling priorities of lots employed in a MES (Manufacturing Execution System) for use in semiconductor manufacturing processes, the MES including an equipment computer for managing the semiconductor manufacturing processes, a management computer for administratively managing the semiconductor manufacturing processes, and a server system for automatically setting up the priorities of the lots by using data on processing cycle time received from the equipment computer and the management computer, comprising the steps of: (a) setting up estimated time of the processing cycle time by inputting queue time and process time for each process in the semiconductor manufacturing processes by using the management computer; (b) measuring the measured time of the processing cycle time by using start time and finish time of said each process by using the equipment computer; (c) setting up a setup ratio of a reflected measured time to be reflected in said each process to the estimated time in order to obtain the processing cycle time to be actually used; (d) calculating the processing cycle time to be actually used on the basis of the reflected measured time; (e) creating a list containing the priorities of the lots based on the processing cycle time calculated at step (d); and (f) displaying the list created at step (e) containing the priority of the lots.

According to another aspect of the present invention, there is also provided a system for controlling priority of lots employed in a MES (Manufacturing Execution System) for use in processes employed in a semiconductor manufacturing, comprising: a LAN (Local Area Network) for connecting various equipment for network communication; an equipment computer for managing the semiconductor manufacturing processes; a management computer for administratively managing the product manufacturing process; and a MES (Manufacturing Execution System) including a network interface card for physically connecting with the LAN for data transfer, a key input unit for inputting data, a data memory for storing data inputted from the key input unit or received via the network interface card, a program memory for storing a program for a method for controlling the priority of lots, a control unit for supervising and controlling operations in the whole system, a monitor for displaying data processing and progress status in the system on a screen thereof, and a database for storing data inputted from the equipment computer and the management computer, wherein the equipment computer, the management computer and the MES are connected through the LAN, and wherein the MES calculates the priority of the lots on the basis of measured time of processing cycle time received from the equipment computer and estimated time of the processing cycle time received from the managing computer, thereby creating a list containing the priority of the lots and controlling output of the list.

### BRIEF DESCRIPTION OF THE DRAWINGS

The above and other objects and features of the present invention will become apparent from the following description of preferred embodiments given in conjunction with the accompanying drawings, in which:

FIG. 1 is a schematic view showing a processing cycle time in a semiconductor manufacturing process;

FIG. 2 is a schematic view showing a due date for a lot in the semiconductor manufacturing process;

FIG. 3 is a schematic block diagram showing the constitution of a system for controlling priority of lots employed in a MES according to the present invention;

FIG. 4 is a schematic block diagram showing the inner constitution of the MES 30;

FIGS. 5A and 5B are a flow charts showing a method for controlling priority of the lots in the MES according to the present invention;

FIG. 6 shows an image on which estimated time of the processing cycle time is inputted;

FIG. 7 shows an image on which operation start time of the measured time of the processing cycle time is transmitted;

FIG. 8 shows an image on which operation finish time of the measured time of the processing cycle time is shown to be transmitted; and

FIG. 9 shows an image on which a list containing the priority of the lots depending on the processing cycle time is displayed.

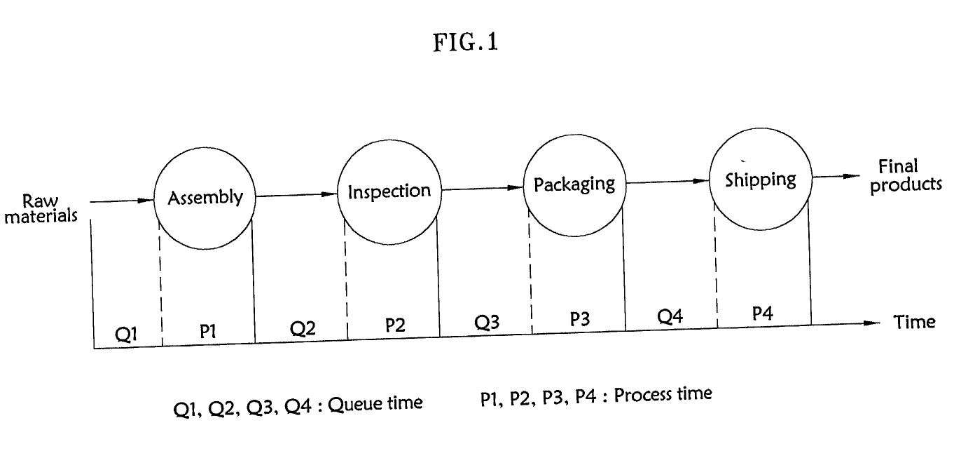

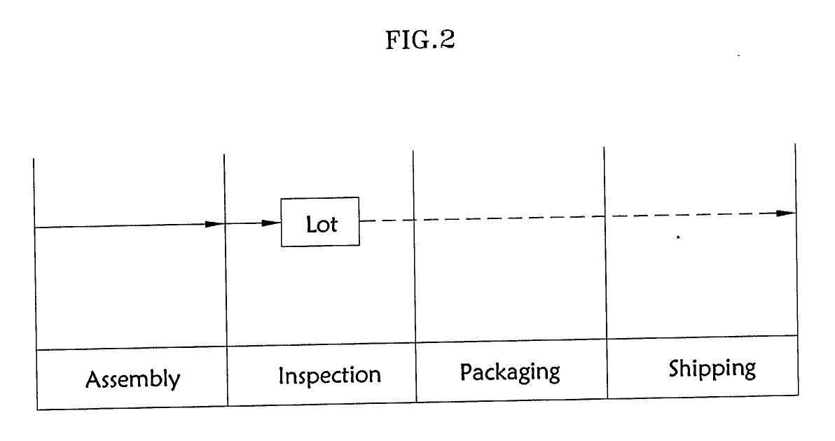

### DETAILED DESCRIPTION OF THE PREFERRED EMBODIMENTS

Hereinafter, preferred embodiments of the present invention will be explained with reference to the accompanying drawings.

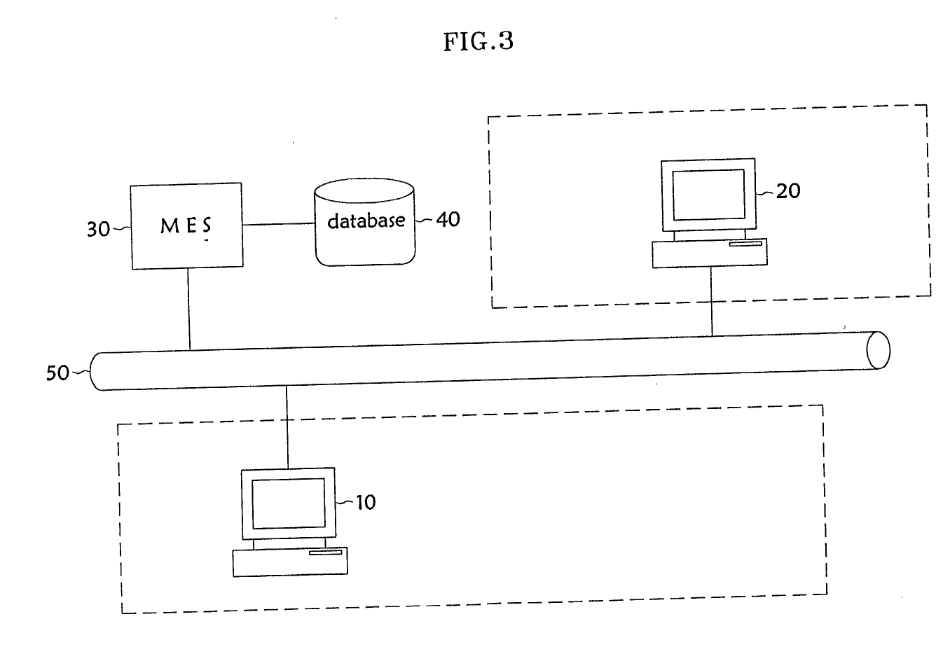

FIG. 3 is a schematic block diagram showing the constitution of a system for controlling priority of lots employed in a MES in accordance with the present invention.

In FIG. 3, reference numeral 10 denotes an equipment computer for managing product manufacturing processes, reference numeral 20 denotes a management computer for administratively managing the product manufacturing processes, reference numeral 30 denotes a MES for managing progress and history of the lots, and various resources on a semiconductor manufacturing site, and reference numeral 40 denotes a database for storing data inputted from the equipment computer 10 and the management computer 20. Further, reference numeral 50 denotes a LAN (Local Area Network) connecting the equipment computer 10, the management computer 20, the MES 30 and the database 40. That is, the equipment computer 10, the management computer 20, the MES 30, and the database 40 exchange data through the LAN 50.

The MES 30 controls operations associated with an automatic calculation and setup of the priority of the lots on the basis of data on the processing cycle time received from the equipment computer 10 and the management computer 20.

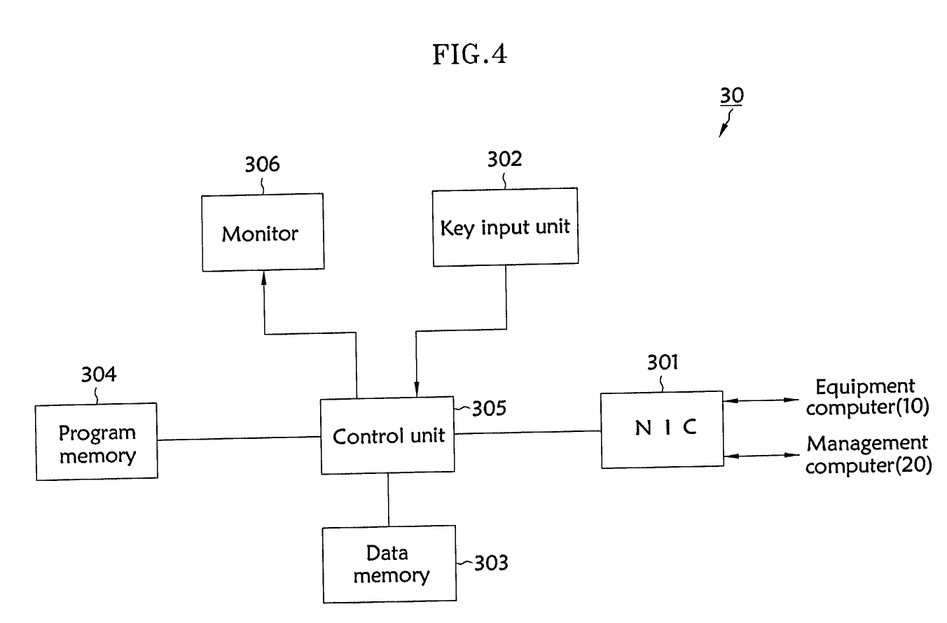

FIG. 4 is a schematic block diagram showing the constitution of the MES 30.

The MES 30 includes an NIC (Network Interface Card) 301 for physically connecting a communication network for communication with other systems, a key input unit 302 for inputting data, a data memory 303 for storing data inputted from the key input unit 302 or received via the NIC 301, a program memory 304 for storing a program for the method for controlling the priority of the lots in accordance with the present invention, a control unit 305 for supervising and commanding operations of the units and memories in the MES, and a monitor 306 for displaying data processing and operation status in the MES 30 on a screen thereof.

Meanwhile, the equipment computer 10 and the management computer 20 have similar structures to the MES 30, there is, however, a difference therebetween in that the program stored in a program memory is mainly run in support of transmitting data to the MES 30.

The control unit 305 in the MES 30 calculates the priority of the lots on the basis of the measured time of the processing cycle time received from the equipment computer 10 and the estimated time of the processing cycle time received from the managing computer 20, thereby creating a list containing the priority of the lots, and controls the presentation of the list.

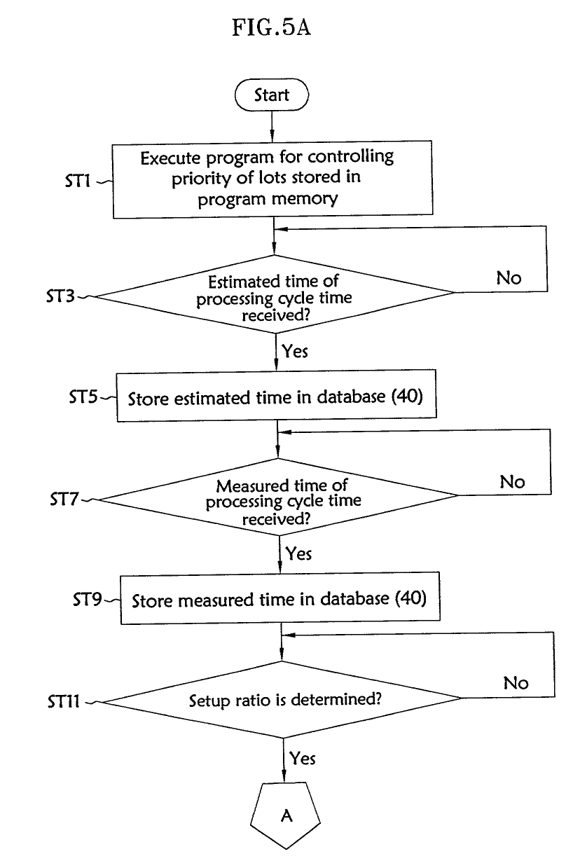

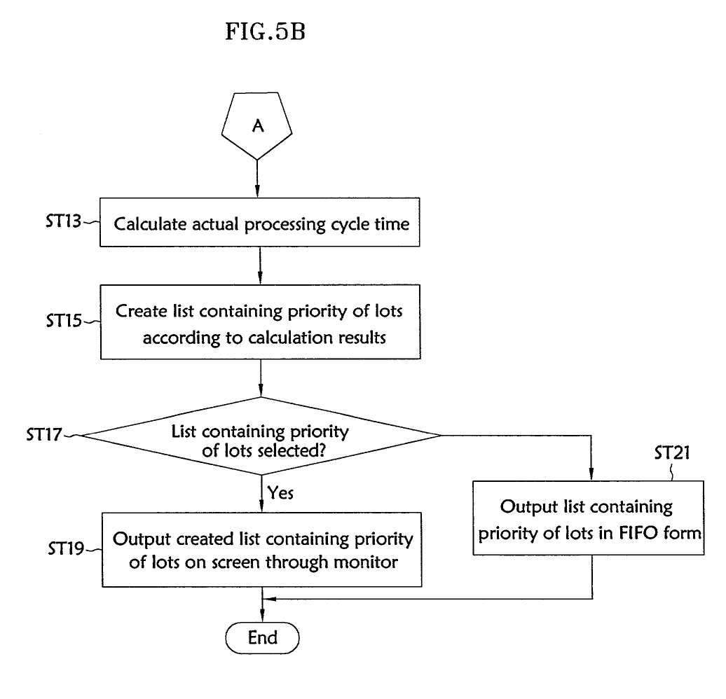

Hereinafter, the operation of the system having the constitution as described above will be explained with reference to the flow diagram shown in FIGS. 5A and 5B.

First, in the MES 30, an image for presenting the server's functions is displayed on the monitor 306 when the MES 30 starts up operation, and an operator inputs a command for executing a program for controlling the priority of the lots by using the key input unit 302.

When the command for executing the program for controlling the priority of the lots is inputted, the control unit 305 executes the program in the program memory 304. Then, an image for controlling the priority of the lots in the manufacturing processes is displayed on the monitor 306 (step ST1).

Meanwhile, similarly, the equipment computer 10 located on the manufacturing site and the management computer 20 located at an office or the like are brought under a state capable of communicating with the MES 30 so as to receive and transmit data from and to the MES 30 by means of execution of a program installed in the computer by the operator.

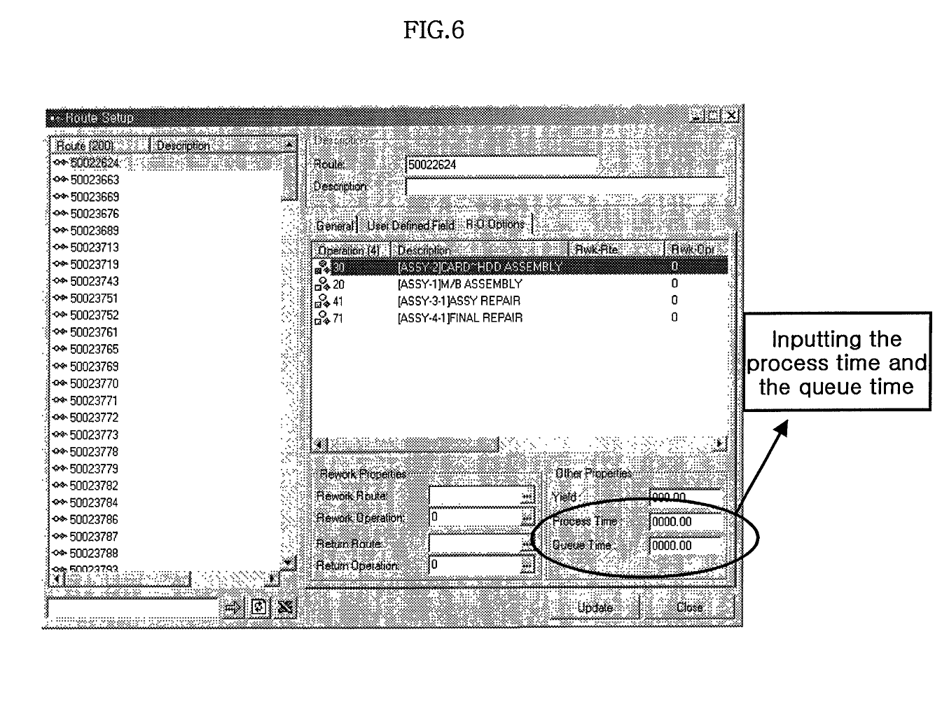

That is, when the operator of the management computer 20 executes the program for controlling the priority of the lots, the management computer 20 outputs an image for inputting queue time and process for respective processes on the monitor (not shown) as shown in FIG. 6.

Subsequently, upon the operator's input of the queue time and the process time the operator expects into the management computer 20, the management computer 20 transmit the inputted time to the MES 30. When the estimated time is set up by inputting the queue time and the process time, the operator sets up limit time of the estimated time through the key input unit 302. For example, the estimated time is set up in the form of ±30 minutes. The MES 30 determines whether the estimated time of the processing cycle time is received from the management computer 20 (step ST3). If the estimated time is received, the control unit 305 stores the received estimated time of the processing cycle time in the database 40 (step ST5).

Meanwhile, referring to the equipment computer 10 located on the manufacturing site, before each processing operation starts after the operator turns on the equipment computer 10, start time and finish time of the processing operation are transmitted to the MES 30 through the equipment computer 10.

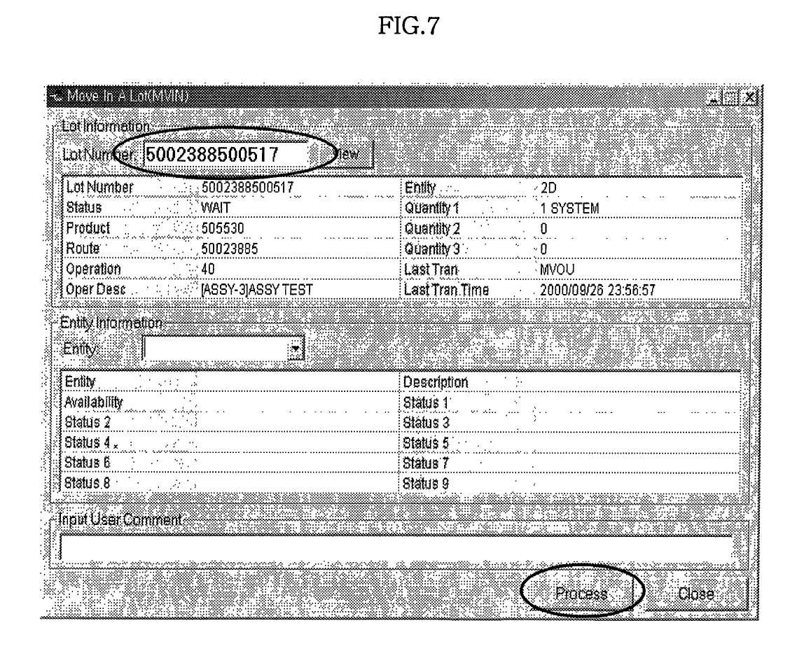

FIG. 7 shows an image on which operation start time of the measured time among the processing cycle time is transmitted.

Before each process starts up, data containing a lot number are inputted in the screen shown in FIG. 7. By clicking a “Process” button, data notifying start of the current process are transmitted to the MES 30.

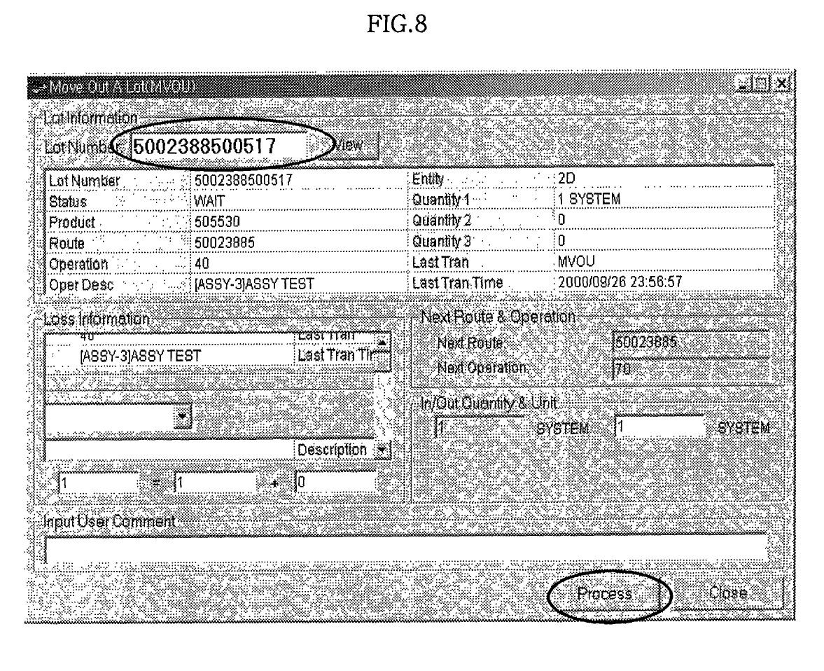

FIG. 8 shows an image on which operation finish time of the measured time among the processing cycle time is transmitted.

After each process has been completed, data containing a lot number are inputted in the screen shown in FIG. 8. By clicking a “Process” button, data notifying finish of the current process are transmitted to the MES 30. When the MES 30 receives the measured time of the processing cycle time from the equipment computer 10 (step ST7), the control unit 305 stores the measured time of the received processing cycle time in the database 40 (step ST9). The measured time stored in the database 40 is accumulatively stored whenever the lots undergo a process. Thereafter, the control unit 305 obtains the processing cycle time by calculating the accumulatively stored data.

Subsequently, after confirming receipt of the estimated time of the processing cycle time from the management computer 20 and the measured time of the processing cycle time from the equipment computer 10, the operator at the MES 30 side sets up a setup ratio of the measured time to be reflected in the estimated time for the corresponding processes as a percentage. For example, when the estimated time is 3 hours, the measured time is 4 hours, and the percentage is set to 100%, in spite of the estimated time of 3 hours estimated before start of the work, the measured time is fully reflected in the estimated time, and therefore, the processing cycle time becomes 4 hours.

When the setup ratio of the measured time to the estimated time is determined (step ST 11), the control unit 305 calculates actual processing cycle time by estimating each processing cycle time according to each setup ratio (step ST 13).

In the above calculation procedure, when the measured time received from the equipment computer 10 and then stored in the database 40 exceeds an estimation limit time, the control unit 305 excludes the measured time from the calculation of the actual processing cycle time and calculates the actual processing cycle time with only the time falling within the limit time.

In addition, when the measured time does not fall within the range of the limit time many times, e.g., 10 times, the control unit 305 notifies the fact that the calculation of the processing cycle time cannot be performed, on the screen.

Meanwhile, the control unit 305 creates a list containing the priority of the lots (step ST15). That is, according to the duration of the operation time, the list is created by classifying the respective processing cycle time. When the operator of the MES 30 refers to the created list containing the priority of the lots, the operator should select how to refer to the resulting list.

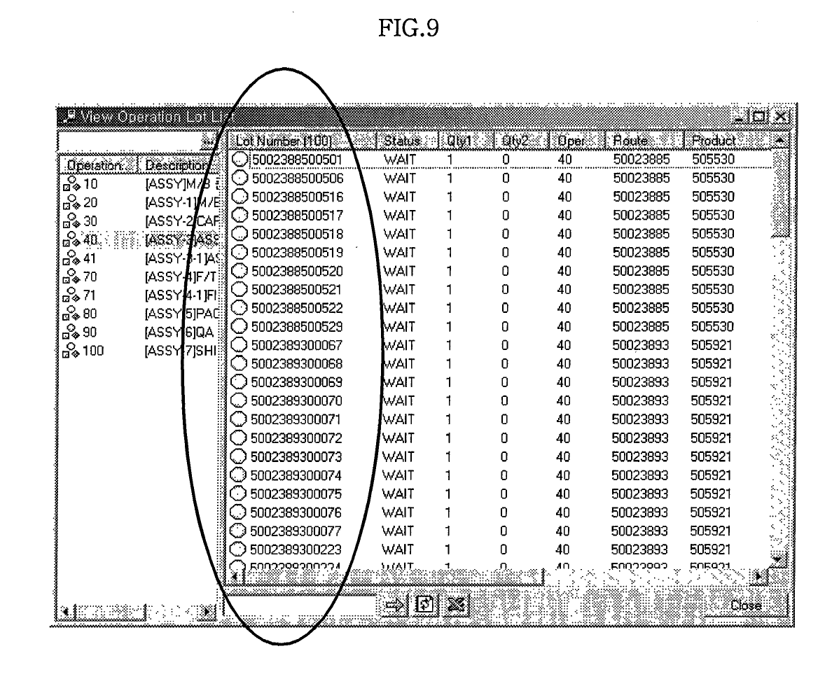

FIG. 9 shows an image on which the list containing the priority of the lots depending on the processing cycle time is displayed.

That is, when the operator selects the reference of the priority obtained according to the setup ratio of the measured time to be reflected in the estimated time (step ST17), the control unit 305 outputs the list containing the priority of the lots on the screen shown in FIG. 9 by way of the monitor 306 (step ST19).

At step ST17, however, when the operator selects the reference of a FIFO (First-In-First-Out) format rather than the above reference form obtained according to the present invention in order to obtain the list of the priority of the lots, the control unit 305 refers and shows the list containing the priority of the lots in the FIFO format (step ST21).

As explained above, according to the embodiments of the present invention, there are advantages in that the process time in the manufacturing line can be reduced, and thus, the process can be efficiently performed since the list containing the priority of the lots is automatically created by inputting only several data.

While the invention has been shown and described with respect to the preferred embodiments, it will be understood by the skilled in the art that various changes and modifications may be made without departing from the spirit and scope of the invention as defined in the following claims.

What is claimed is:

1. A method for controlling priorities of lots employed in a MES (Manufacturing Execution System) for use in semiconductor manufacturing processes, the MES including an equipment computer for managing the semiconductor manufacturing processes, a management computer for administratively managing the semiconductor manufacturing processes, and a server system for automatically setting up the priorities of the lots by using data on processing cycle time received from the equipment computer and the management computer, comprising the steps of:
(a) setting up estimated time of the processing cycle time by inputting queue time and process time for each process in the semiconductor manufacturing processes by using the management computer;
(b) measuring the measured time of the processing cycle time by using start time and finish time of said each process by using the equipment computer;
(c) setting up a setup ratio of a reflected measured time to be reflected in said each process to the estimated time in order to obtain the processing cycle time to be actually used;
(d) calculating the processing cycle time to be actually used on the basis of the reflected measured time;
(e) creating a list containing the priorities of the lots based on the processing cycle time calculated at step (d); and
(f) displaying the list created at step (e) containing the priority of the lots.

2. The method for controlling the priorities of the lots in the MES as claimed in claim 1, wherein in step (a), the estimated time has marginal limits represented as percentage, the marginal value indicating a margin of variation of the estimated time.

3. The method for controlling the priority of the lots in the MES as claimed in claim 1, wherein in step (b), the measured time is calculated by adding the processing cycle time which corresponds to each process performed at said each lot.

4. The method for controlling the priority of the lots in the MES as claimed in claim 1, wherein in step (b), when the measured time exceed the marginal limits, the measured time is excluded from the calculation of the measured time of the processing cycle time.

5. The method for controlling the priority of the lots in the MES as claimed in claim 2, wherein in step (b), when the measured time exceed the marginal limits, the measured time is excluded from the calculation of the measured time of the processing cycle time.

6. The method for controlling the priority of the lots in the MES as claimed in claim 1, wherein in step (b), when the measured time does not fall within the range of the marginal limits for predetermined times, it is determined that the calculation of the processing cycle time cannot be performed.

7. The method for controlling the priority of the lots in the MES as claimed in claim 2, wherein in step (b), when the measured time does not fall within the range of the marginal limits for predetermined times, it is determined that the calculation of the processing cycle time cannot be performed.

8. The method for controlling the priority of the lots in the MES as claimed in claim 1, wherein in step (e), the list is generated by using the priorities obtained on a FIFO (First-In-First-Out) basis.

9. A system for controlling priority of lots employed in a MES (Manufacturing Execution System) for use in processes employed in a semiconductor manufacturing, comprising:
a LAN (Local Area Network) for connecting various equipment for network communication;
an equipment computer for managing the semiconductor manufacturing processes;
a management computer for administratively managing the product manufacturing process; and
a MES (Manufacturing Execution System) including a network interface card for physically connecting with the LAN for data transfer, a key input unit for inputting data, a data memory for storing data inputted from the key input unit or received via the network interface card, a program memory for storing a program for a method for controlling the priority of lots, a control unit for supervising and controlling operations in the whole system, a monitor for displaying data processing and progress status in the system on a screen thereof, and a database for storing data inputted from the equipment computer and the management computer,
wherein the equipment computer, the management computer and the MES are connected through the LAN, and
wherein the MES calculates the priority of the lots on the basis of measured time of processing cycle time received from the equipment computer and estimated time of the processing cycle time received from the managing computer, thereby creating a list containing the priority of the lots and controlling output of the list.
